(19) United States
(12) Patent Application Publication
(10) Pub. No.: US 2006/0179015 A1
(43) Pub. Date: Aug. 10, 2006

(54) Procedure based decision support

(75) Inventors: Mark M. Morita, Arlington Heights, IL (US); Steven L. Fors, Chicago, IL (US); Khaldoun A. Rai, Round Lake, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 10/997,106

(22) Filed: Nov. 24, 2004

(51) Int. Cl. G06F 15/18

(52) U.S. Cl. 706/14

(57) ABSTRACT

Certain embodiments of the present invention provide a system, method and computer instructions for providing procedure based decision support. In an embodiment, a procedure based decision support system includes a procedure input module that allows a user to input a procedure; a procedure identification module that identifies procedures that are the same and/or similar to the input procedure; and an output module that outputs information based on the identified procedures. The procedure based decision support system may also include a decision support activation module that activates the procedure based decision support system, for example.

### BACKGROUND OF THE INVENTION

The present invention generally relates to a system, method and computer instructions for providing procedure based decision support. More particularly, the present invention relates to a system, method and computer instructions for inputting a procedure, identifying relevant procedures and outputting information.

When making a decision, it is often beneficial to have access to the circumstances and decisions reached by previous decision-makers that were confronted with a similar, and perhaps the same, decision. Unfortunately, relevant information does not always exist. Further, in situations where relevant information does exist there is often no good way to identify and access the relevant information, which may lead to one of two results, for example, the information may be ignored or the decision-maker may search through the information manually to identify relevant information. If the information is ignored, it is of no value to the decision-maker. On the other hand, if the decision-maker sifts through the information manually, a benefit may be conferred, but the time required to identify and access the relevant information may outweigh the benefit of having the relevant information available. Thus, a system, method and computer instructions that supply relevant information for decision-makers are highly desirable.

One example of a situation where access to decisions made by previous decision-makers would be beneficial is in a medical setting. For example, when a radiologist is making a diagnosis based on a rare exam, one of the major workflow problems that the radiologist encounters is in the review of previously performed exams with similar procedures. Currently, radiologists must manually process information regarding previously performed exams, which is so time consuming and complex that most radiologists are unable to review previous exams at all. Any value that may be conferred by reviewing previously performed exams is therefore lost. However, if there was a system that gave radiologists instant access to relevant previously performed exams and studies, the information could be used to aid in the current radiologist's decision-making process.

Thus, there is a need for a system, method and computer instructions that provide procedure based decision support.

### BRIEF SUMMARY OF THE INVENTION

Certain embodiments of the present invention provide a system, method and computer instructions for providing procedure based decision support. In an embodiment, a procedure based decision support system includes a procedure input module that allows a user to input a procedure; a procedure identification module that identifies procedures that are the same type as and/or similar to the input procedure; and an output module that outputs information based on the identified procedures. The procedure based decision support system may also include a decision support activation module that activates the procedure based decision support system, for example.

In an embodiment, a method for providing procedure based decision support includes inputting a procedure, identifying procedures that are the same type as and/or similar to the input procedure, and outputting information based on the identified procedures. The method for providing procedure based decision support may also include activating procedure based decision support, for example.

In an embodiment, a computer-readable storage medium includes a set of instructions for a computer directed to providing procedure based decision support. The set of instructions includes a procedure input routine that allows a user to input a procedure; a procedure identification routine that identifies procedures that are the same type as and/or similar to the input procedure; and an output routine that outputs information based on the identified procedures. The set of instructions may also include a decision support activation routine that activates the procedure based decision support, for example.

These and other features of the present invention are discussed or apparent in the following detailed description of certain embodiments of the invention.

### BRIEF DESCRIPTION OF THE DRAWINGS

FIG. 1 illustrates a procedure based decision support system used in accordance with an embodiment of the present invention.

FIG. 2 illustrates a flow diagram for a method for providing procedure based decision support used in accordance with an embodiment of the present invention.

FIG. 3 illustrates a set of computer instructions for providing procedure based decision support used in accordance with an embodiment of the present invention.

FIG. 4 illustrates an example of an output in the form of a visual display.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

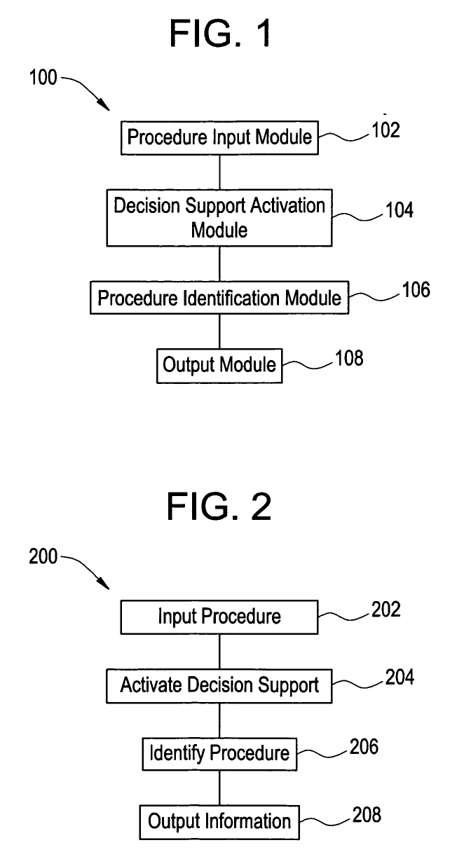

FIG. 1 illustrates a procedure based decision support system 100 that provides procedure based decision support for medical procedures used in accordance with an embodiment of the present invention. The procedure based decision support system 100 includes a procedure input module 102, a decision support activation module 104, a procedure identification module 106 and an output module 108. The components of the system 100 may be implemented in many ways. For example, the components may be implemented in hardware and/or software. The components may be implemented separately and/or integrated in various combinations. Other desirable ways to implement the components of the system 100 may exist.

In the procedure based decision support system 100, the procedure input module 102 allows a user to input a procedure. For example, a procedure may be input into the procedure input module 102 by selecting the procedure from a user-interfaced visual display. Other desirable ways to input procedures into the procedure input module 102 may exist. The decision support activation module 104 allows a user to activate decision support. The procedure identification module 106 identifies procedures that are the same type as and/or similar to the procedure input into the procedure input module 102. The output module 108 outputs information regarding the procedures and/or studies identified by the procedure identification module 106.

The procedure input module 102 may be configurable. For example, the procedure input module 102 may be configured to allow a user to input multiple procedures at once. Other desirable ways to configure the procedure input module 102 may exist.

In the procedure based decision support system 100, the decision support activation module 104 allows a user to activate decision support. For example, the decision support activation module 104 may be triggered by checking a checkbox on a user-interfaced visual display. Other desirable ways to trigger the decision support activation module 104 may exist.

The decision support activation module 104 may be configurable. For example, the decision support activation module 104 may be configured to activate decision support automatically. The decision support activation module 104 may also be configured to activate decision support unless decision support has been manually disabled. Other desirable ways to configure the decision support activation module 104 may exist.

In the procedure based decision support system 100, the procedure identification module 106 identifies procedures that are the same type as and/or similar to the procedure input into the procedure input module 102. The procedure identification module 106 may be configurable. For example, the procedure identification module 106 may be configured to identify only procedures that are the same type as the procedure input into the procedure input module 102. The procedure identification module 106 may also be configured to identify procedures that are the same type as and/or similar to the procedure input into the procedure input module 102. The procedure identification module 106 may be configured to identify procedures from a patient history, a library and/or other data sources, for example. Other desirable ways to configure the procedure identification module 106 may exist.

In the procedure based decision support system 100, the output module 108 outputs information based on the procedures identified by the procedure identification module 106. The output module 108 may be configured to output many types of information. For example, the output module 108 may be configured to output the procedures identified by the procedure identification module 106. The output module 108 may also be configured to output the date the procedure was used, the contact information for the person that used the procedure, notes regarding that particular use of the procedure, as well as other information. The output module 108 may be configured to output entire studies that contain the procedures identified by the procedure identification module 106, for example. It may be desirable to configure the output module 108 to output other types of information.

The output module 108 may be configured to output information in many ways. For example, the output may be a visual display, an audio display, printed matter, a facsimile transmission, and/or electronic mail. Other desirable ways for the output module 108 to output information may exist.

The procedure based recommendation system 100 may be configurable. For example, the system 100 may be configured such that decision support is activated automatically. The system 100 may also be configured such that a user may activate decision support via a decision support activation module 104. Other desirable ways to configure the procedure based recommendation system 100 may exist.

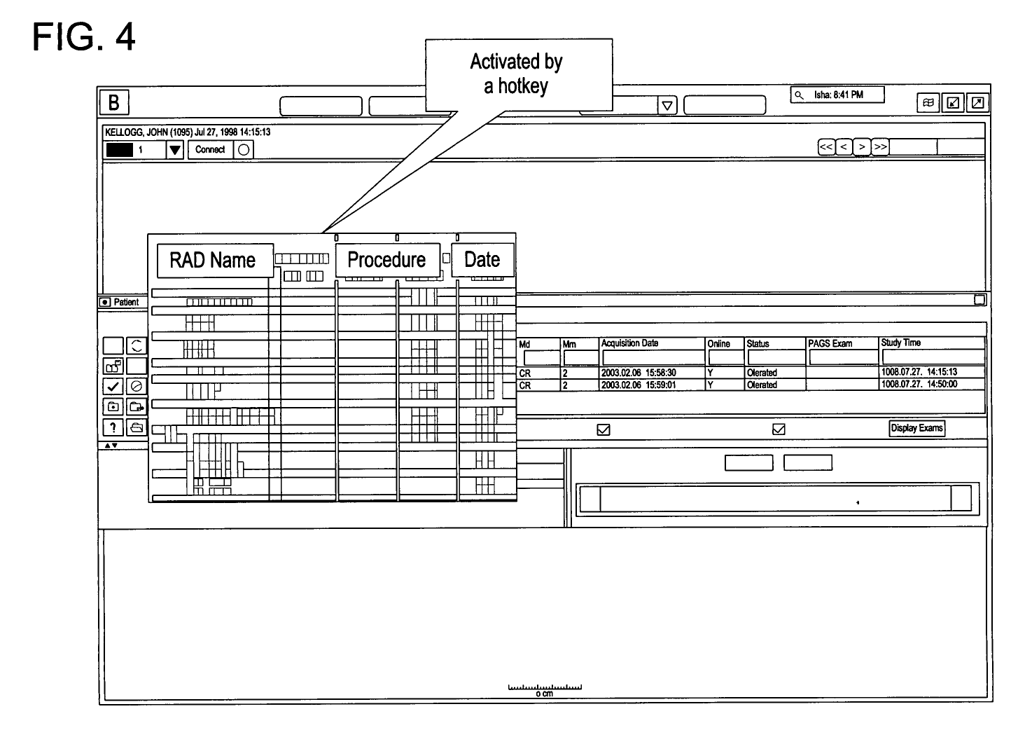

In operation, the procedure based recommendation system 100 is used in connection with a system, such as a Picture Arching and Communicating System (PACS) and/or Radiology Information System (RIS), where procedures are used and tracked. First, a user of a procedure inputs the procedure into the procedure input module 102. For example, the user selects the procedure from a user-interfaced visual display or enters a code corresponding to the procedure. Then, the user activates decision support by triggering the decision support activation module 104. For example, the user checks a checkbox on a user-interfaced visual display or selects a button activating decision support. Then, the procedure identification module 106 identifies past uses of the same and/or similar procedures. For example, the inputted procedure is compared to a database of previously used procedures and matching procedures and/or similar procedures are identified. Finally, the output module 108 outputs information regarding the identified procedures. For example, a listing of identified procedures may be output in the form of a visual display. The contact information for users of identified procedures may also be output in the form of a visual display, for example. As shown in FIG. 4, information, such as contact information, may be accessed in the context of a user-interfaced system by striking a hot key or clicking a visually displayed button. Further, the output may be in the form of a list, showing all identified procedures as well as the other information specified above, for example. Information regarding entire studies that contain the procedures identified by the procedure identification module 106 may also be output, for example.

The procedure based recommendation system 100 may be used in connection with any type of system where procedures are used and tracked. For example, the procedure based recommendation system 100 may be used in connection with a medical system and/or a clinical care system.

FIG. 2 illustrates a flow diagram for a method 200 for providing procedure based decision support 200 used in accordance with an embodiment of the present invention. At 202, a procedure is input. For example, a user inputs a procedure he or she wishes to use into an information system by selecting the procedure from a user-interfaced visual display. At 204, decision support is activated. For example, the user activates decision support by checking a checkbox on a user-interfaced visual display. At 206, previous uses of the same type of procedure and/or similar procedures are identified. For example, a database containing information regarding procedure use is accessed and searched for procedures that are the same type as and/or similar to the input procedure. At 208, information regarding identified procedures is output. For example, a list of the procedures identified at 206 are output in the form of a visual display, an audio display, printed matter, a facsimile transmission, and/or electronic mail. Other information, such as information regarding studies that contain the procedures identified by the procedure identification module 106 may also be output, for example.

The method 200 for providing procedure based decision support may be applied in a medical setting, a clinical care setting or any other setting where procedures are used and tracked. For example, the method 200 may be used in connection with procedure based decision support for radiologists.

When a radiologist performs an exam, for example, the radiologist steps through a sequence of procedures. Then, based on the results of the exam, the radiologist makes a diagnosis. In deciding on a diagnosis, it may be helpful to have the results of similar exams available for comparison. However, it may be difficult to locate previous similar exams.

Applying the method 200 may aid radiologists in identifying similar studies by allowing the radiologist to search through previous exams to find exams that used the same and/or similar procedures. For example, when a radiologist performs a complex procedure, like a liver related procedure called a Percotanious Transhipatic Colangiography, or a Lumbar Myelography Screening for Vascular Malformation for a spinal cord patient, it may be helpful to have access to prior exams where the same procedure was used. By inputting either procedure and then activating decision support, a radiologist may gain access to images, reports and diagnostics from previous exams. Information regarding the previous exam may be output in the form of a visual display that can be compared to the exam the radiologist is formulating a diagnosis for. Further, contact information for the radiologist that performed the previous exam or information regarding an entire study may also be output in the form of a visual display. Information regarding when and how often a procedure is performed may also be displayed.

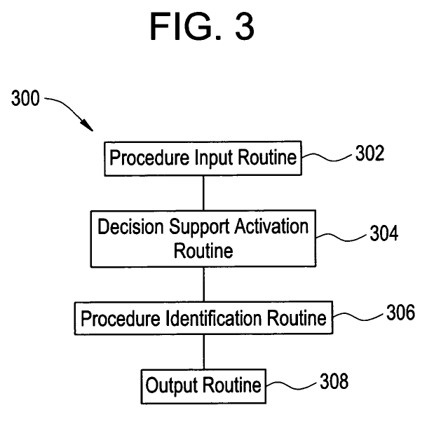

FIG. 3 illustrates a set of computer instructions 300 for providing procedure based decision support used in accordance with an embodiment of the present invention. The set of computer instructions 300 for recommending functionality includes a procedure input routine 302, a decision support activation routine 304, a procedure identification routine 306 and an output routine 308. The set of computer instructions 300 may be implemented on one or more computing systems, for example. For example, the set of computer instructions 300 may be implemented on a RIS and/or PACS system.

In the set of computer instructions 300 for providing procedure based decision support, the procedure input routine 302 allows a user to input a procedure. The decision support activation routine 304 allows a user to activate decision support. The procedure identification routine 306 identifies procedures that are the same type as and/or similar to the procedure input into the procedure input module 302. The output routine 308 outputs information regarding procedures identified by the procedure identification routine 306.

In an embodiment, the procedure input routine 302, the decision support activation routine 304, the procedure identification routine 306 and the output routine 308, may perform functions similar to the procedure input module 102, the decision support activation module 104, the procedure identification module 106 and the output module 108, respectively, as described above in relation to FIG. 1.

The set of computer instructions 300 for providing procedure based decision support may be used in connection with any type of system where procedures are used and tracked. For example, the set of computer instructions for recommending functionality 300 may be used in connection with a medical system and/or a clinical care system.

Thus, certain embodiments of the present application provide a system and method for supporting healthcare practitioners when performing procedures and/or reading and diagnosing examination results. Certain embodiments improve diagnosis time through collaboration with prior studies and/or users. Certain embodiments provide decision support through generation of a contact list and/or support based on procedure type, for example.

Certain embodiments facilitate automatic identification of related studies based on procedures performed and automatically related images. Certain embodiments automatically provide a list of local experts based on previously performed procedures. Additionally, certain embodiments allow comparison between current studies and previously diagnosed studies using procedure-based display and layout protocols.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A procedure based decision support system for use with medical procedures comprising:
a procedure input module that allows a user to input a procedure;
a procedure identification module capable of at least one of the following:
identifying procedures similar to the procedure input into the procedure input module and; identifying procedures that are the same type as the procedure input into the procedure input module; and
an output module that outputs information based on the procedures identified by the procedure identification module.

2. The system of claim 1, wherein said output module outputs the procedures identified by the procedure identification module.

3. The system of claim 1, wherein said output module outputs procedures based on the type of procedure input into the procedure input module.

4. The system of claim 1, wherein said output module outputs a contact list based on the procedures identified by the procedure identification module.

5. The system of claim 1, wherein said output module outputs a contact list based on the type of procedure input into the procedure input module.

6. The system of claim 1, wherein the output module outputs information such that the output information can be compared to the input procedure.

7. The system of claim 1, further comprising a decision support activation module that activates the decision support system.

8. A method for providing procedure based decision support comprising:
inputting a medical procedure;
identifying at least one of prior procedures similar to the input procedure; and prior procedures that are the same type as the input procedure; and
outputting information based on the identified procedures.

9. The method of claim 8, wherein the information output is the identified procedures.

10. The method of claim 8, wherein the information output is based on the procedure type of the input procedure.

11. The method of claim 8, wherein the information output is a contact list based on the identified procedures.

12. The method of claim 8, wherein the information output is a contact list based on the procedure type of the input procedure.

13. The method of claim 8, wherein the output information is output such that the output information can be compared to the input procedure.

14. The method of claim 8, further comprising activating procedure based decision support.

15. A computer-readable storage medium including a set of instructions for a computer for use with medical procedures, the set of instructions comprising:
a procedure input routine that allows a user to input a procedure;
a procedure identification routine capable of at least one of the following:
identifying procedures similar to the procedure input into the procedure input routine and; identifying procedures that are the same type as the procedure input into the procedure input routine; and
an output routine that outputs information based on the procedures identified by the procedure identification routine.

16. The system of claim 15, wherein said output routine outputs the procedures identified by the procedure identification routine.

17. The system of claim 15, wherein said output routine outputs procedures based on the type of procedure input into the procedure input routine.

18. The system of claim 15, wherein said output routine outputs a contact list based on the procedures identified by the procedure identification routine.

19. The system of claim 15, wherein said output routine outputs a contact list based on the type of procedure input into the procedure input routine.

20. The system of claim 15, wherein the output routine outputs information such that the output information can be compared to the input procedure.

21. The system of claim 15, further comprising a decision support activation routine that activates the decision support system.
